(19) United States
(12) Patent Application Publication
(10) Pub. No.: US 2018/0250797 A1
(43) Pub. Date: Sep. 6, 2018

(54) RATCHET WRENCH

(71) Applicants: CHUN-WEI YANG, Taichung (TW); ZHE-PING ZHANG, Taichung (TW)

(72) Inventors: CHUN-WEI YANG, Taichung (TW); ZHE-PING ZHANG, Taichung (TW)

(21) Appl. No.: 15/450,023

(22) Filed: Mar. 5, 2017

(51) Int. Cl. B25B 13/46; B25B 23/00

(52) U.S. Cl. CPC B25B 13/463; B25B 23/0007

(57) ABSTRACT

A ratchet wrench includes a body, a ratchet wheel, a pawl, a top ring, a top clip, bottom ring and a bottom clip. The body includes a through hole defined through the top and the bottom of the body. A top recessed area and a bottom recessed area are respectively defined in the top and the bottom of the body. A recess is defined in the inner periphery of the through hole. A protrusion with a receiving slot extends from one end of the recess. A resilient member is received in the receiving slot to bias the pawl to engage with the ratchet wheel. The top ring is engaged with the top recessed area. The bottom ring is engaged with the bottom recessed area. The top clip and the bottom clip are respectively engaged with the top and bottom recessed areas. The opt ring is pressed by the top clip.

### FIELDS OF THE INVENTION

The present invention is a Continuation-In-Part application of applicant's former patent application with the application Ser. No. 15/424,764, filed on Feb. 3, 2017.

### BACKGROUND OF THE INVENTION

### Descriptions of Related Art

The conventional ratchet wrench known to applicant is disclosed in FIGS. 15 to 17, and comprises a body 91 having a through hole 911, and a recess 912 is defined in the inner periphery of the through hole 911. The recess 912 includes a closed top and a closed bottom. A receiving slot 914 is defined in the inner periphery of the recess 912. A lip 915 extends inward from the bottom of the head 91. A ratchet wheel 92 is rotatably received in the through hole 911 and rested on the lip 915. The ratchet wheel 92 includes a ratchet portion 921 and a connection hole 922. A pawl 93 includes a toothed portion 931 and is received in the recess 912. A resilient member 94 is received in the receiving slot 914 and biases the pawl 93 to engage the toothed portion 931 with the ratchet portion 921. A clip 96 is engaged within the receiving slot 914 and a groove 923 of the ratchet wheel 92 to pivotably position the ratchet wheel 92 in the through hole 911.

However, as shown in FIGS. 16 and 17, the volume of the pawl 93 is ⅗ of the volume of the recess 912, herefore, a space 95 is formed beside the pawl 93. When operating the ratchet wrench and the ratchet wheel 92 is applied by a significant resistance, and the ratchet wrench is rotated counter clockwise, the ratchet wheel 92 directly drives the pawl 93 to move in the recess 912. The larger than space 95 is, the larger the angle that the ratchet wrench is freely rotated. In other words, the pawl 93 is not disengaged from the ratchet wheel 92. In some situation, the angle can be 10 degrees, this wastes the user's time and reduces the efficiency of work. Besides, the recess 912 includes the closed top and the closed bottom, so that only T-shaped blade can be used to make the cavity when manufacturing the head of the wrench. The T-shaped blade is an expensive tool and the size of shank of the T-shaped blade is restricted by the inner periphery of the head so that the shank is easily broken. Furthermore, the lip 915 extends from the inner periphery of the through hole 911 and restricts the operation of the tool to drill the through hole 911. The receiving slot 914 is an inclined slot relative to the pawl 30, so that when drilling the receiving slot 914, the tool has to be carefully controlled to prevent from hitting the inner periphery of the through hole 911. The receiving slot 914 includes three inclined directions relative to the axis of the through hole 911 in X, Y and Z directions. This makes the drilling of the receiving slot 914 more difficult.

U.S. Pat. No. 6,382,051 discloses another ratchet wheel whose recess includes a closed top and a closed bottom, so that it has the similar shortcomings.

The present invention intends to provide a ratchet wrench which is easily manufactured so as to eliminate the shortcomings mentioned above.

### SUMMARY OF THE INVENTION

The present invention relates to a ratchet wrench and comprises a body having a through hole defined through the top and the bottom thereof. The through hole has a recess defined in the inner periphery thereof. The center of the recess is located in the through hole. The recess opens through the top and the bottom of the body. A protrusion extends from one end of the recess and has a receiving slot which includes an opening and an entrance. The opening opens through the top of the body. The entrance of the receiving slot communicates with and faces the interior of the recess. A top recessed area is defined in the top of the body and shares a common axis with the through hole. A first shoulder is formed between the top recessed area and the through hole. The first shoulder is in flush with the top of the protrusion. A bottom recessed area is defined in the bottom of the body and shares the common axis with the through hole.

A ratchet wheel is rotatably received in the through hole and has a ratchet portion defined in the outer periphery thereof. A connection portion is formed to the ratchet wheel. A first pivotal portion and a second pivotal portion are respectively formed on two ends of the ratchet wheel. The first pivotal portion has a top groove. The second pivotal portion has a bottom groove. The second pivotal portion is pivotably engaged with the through hole and the bottom recessed area.

A pawl is movably received in the recess and has a toothed face defined in the front side thereof. The toothed face is engaged with the ratchet portion of the ratchet wheel. The pawl has a positioning portion defined in the first end thereof. The positioning portion faces the entrance. The pawl has a contact end defined in the second end thereof. The contact end contacts the inner periphery of the recess.

A resilient member is received in the recess and biased between the inner end of the receiving slot and the positioning portion to engage the toothed face of the pawl with the ratchet portion of the ratchet wheel.

A top ring is received in the top recessed area and contacts the first shoulder and the top of the protrusion. The top ring has an inner periphery thereof mounted to the first pivotal portion. The top ring is shaped to cover the resilient member. The top ring has a first lid extending from an outer periphery thereof and the lid covers the recess at the top of the body.

A top clip is engaged with the top groove and contacts the ring to restrict the ring from separating from the ratchet wheel. A bottom ring is engaged with the bottom recessed area and contacts the second shoulder. The bottom ring has a second inner periphery which is pivotably connected to the first pivotal portion. The bottom ring has a second lid extending from the outer periphery so as to clover the recess at the bottom of the body.

A bottom clip is engaged with the bottom groove and contacts the second shoulder. The ratchet wheel is restricted by the top ring, the top clip, the bottom ring and the bottom clip so as to be pivotably received in the through hole.

The primary object of the present invention is to provide a ratchet wrench wherein the through hole and the recess open to the top and bottom of the body. The top recessed area and the receiving slot open to the top of the body. The bottom recessed area opens to the bottom of the body. The specific structure allows the manufacturers to easily make the ratchet wrench. The top ring, the top clip, the bottom ring and the bottom clip are respectively mounted to two ends of the ratchet wheel, and supported by the first and second shoulders, so that the ratchet wheel is rotatably received in the through hole. The pawl is restricted in the recess, and the resilient member is secured in the receiving slot. When maintaining the ratchet wrench, the top clip of the bottom clip is removed from the body, the ratchet wheel, the pawl and the resilient member can be replaced easily.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the ratchet wrench of the present invention;

FIG. 2 is a front view of the body of the ratchet wrench of the present invention;

FIG. 3 is a cross sectional view, taken along line 3-3 in FIG. 2;

FIG. 4 is another perspective view to show the body of the ratchet wrench of the present invention;

FIG. 5 is a perspective view to show the ratchet wrench of the present invention;

FIG. 6 is a side view of the ratchet wrench of the present invention;

FIG. 7 is a cross sectional view, taken along 7-7 in FIG. 6;

FIG. 8 is a front view of the ratchet wrench of the present invention;

FIG. 9 is a cross sectional view, taken along 9-9 in FIG. 8;

FIG. 10 is an enlarged view of the circled D in FIG. 9;

FIG. 11 is an exploded view of the second embodiment of the ratchet wrench of the present invention;

FIG. 12 shows the front view of the second embodiment of the body;

FIG. 13 is a cross sectional view, taken along 13-13 in FIG. 12;

FIG. 14 is an enlarged view of the circled D in FIG. 13;

FIG. 15 is an exploded view of a conventional ratchet wrench;

FIG. 16 is a side view of the conventional ratchet wrench in FIG. 15, and

FIG. 17 is a cross sectional view, taken along 17-17 in FIG. 16.

### DETAILED DESCRIPTION OF THE PREFERRED EMBODIMENT

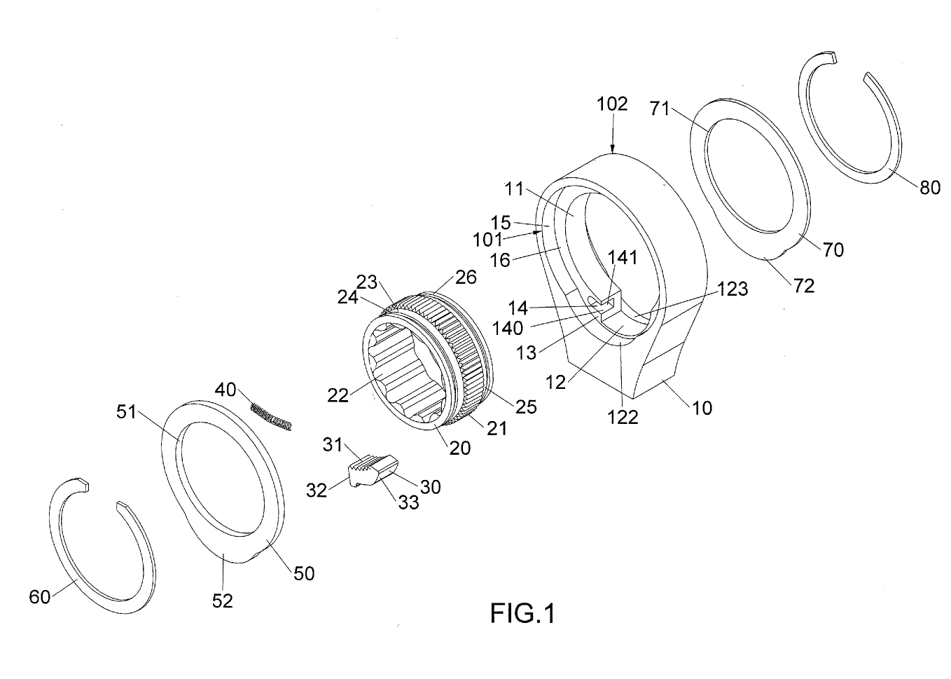

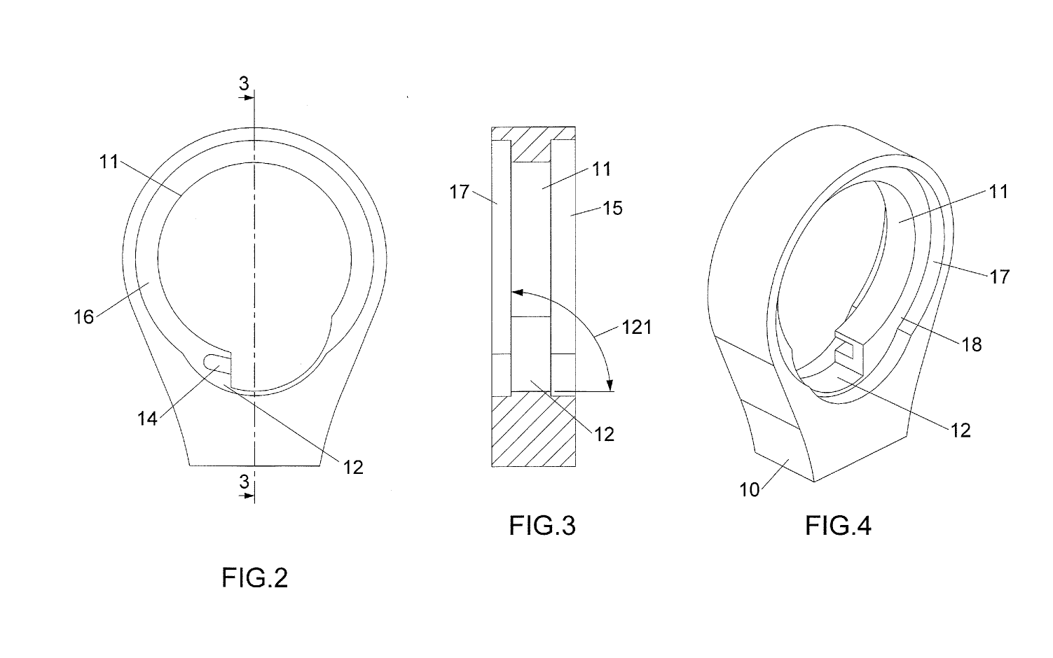

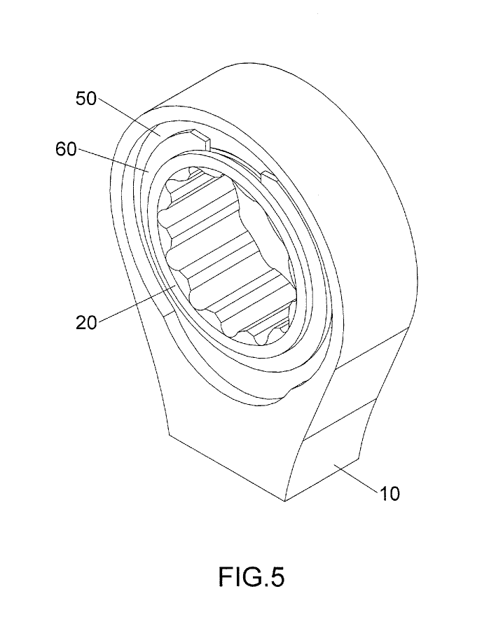

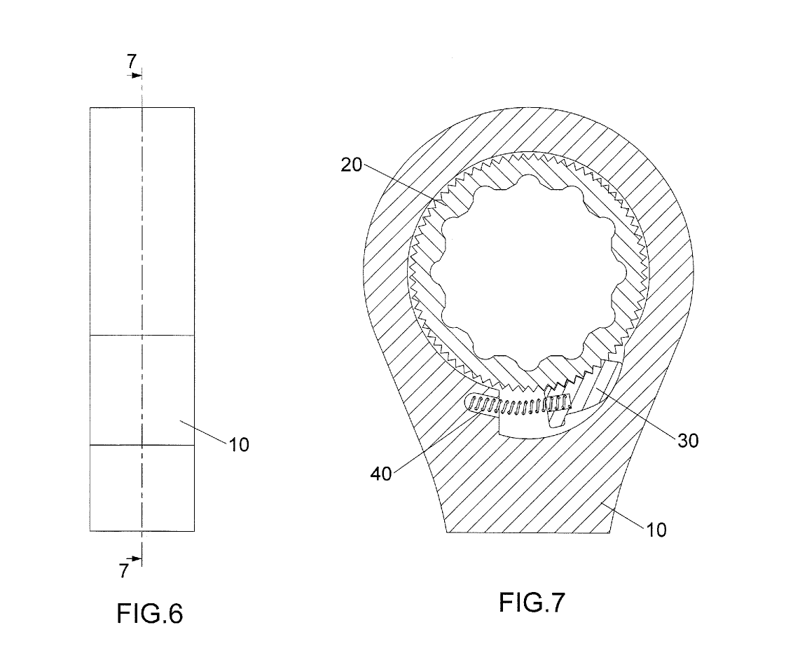

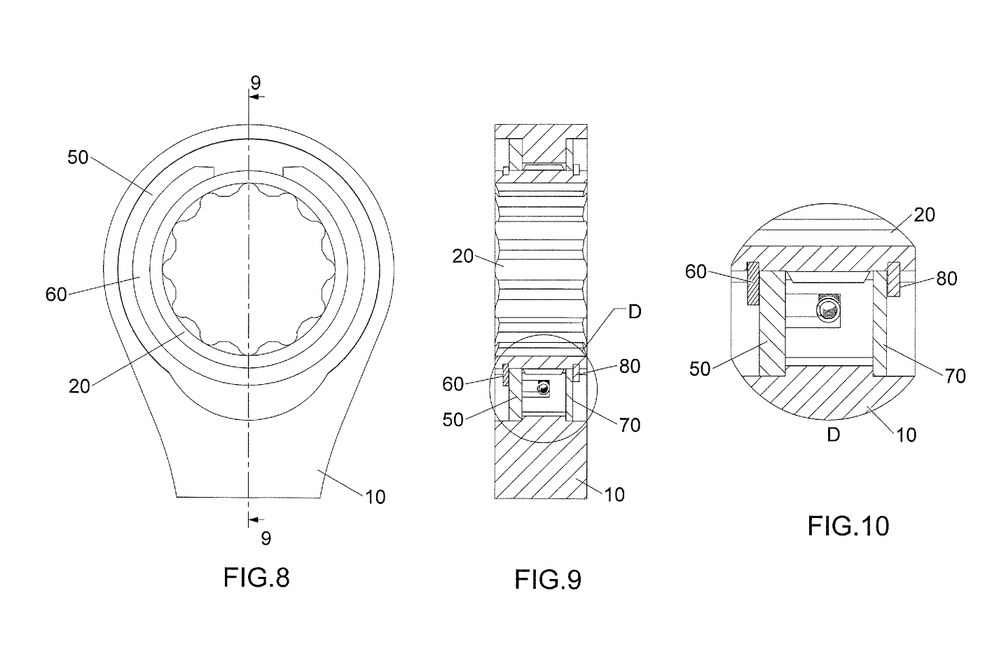

Referring to FIGS. 1 to 10, the ratchet wrench of the present invention comprises a body 10 having a through hole 11 defined through the top 101 and the bottom 102 thereof. The through hole 11 has a recess 12 defined in the inner periphery thereof, and the center of the recess 12 is located in the through hole 11. The recess 12 is opened through the top 101 and the bottom 102 of the body 10. A first angle 121 is defined between the inner end of the first recess 12 and the inner periphery of the first recess 12, wherein the first angle 121 is between 90 to 120 degrees. A protrusion 13 extends from one end of the recess 12 and has a receiving slot 14 which includes an opening 140 and an entrance 141, wherein the opening 140 is opened through the top of the body 10, and the entrance 141 of the receiving slot 14 communicates with and faces the interior of the recess 12. A top recessed area 15 is defined in the top 101 of the body 10 and shares a common axis with the through hole 11. The top recessed area 15 communicates with the through hole 11, the recess 12 and the receiving slot 14. A first shoulder 16 is formed between the top recessed area 15 and the through hole 11. The first shoulder 16 is in flush with the top of the protrusion 13. A bottom recessed area 17 is defined in the bottom of the body 10 and shares the common axis with the through hole 11. The bottom recessed area 17 is located in the bottom 102 of the body 10 and the opening 140 is located in the top 101 of the body 10. The inner diameter of the bottom recessed area 17 is the same as the inner diameter of the top recessed area 15. The top and the bottom recessed areas 15, 17 are located symmetrically to the through hole 11. A first recess 122 is defined in the inner periphery of the top recessed area 15 and located at the top 101 of the body 10. A second recess 123 is defined in the inner periphery of the bottom recessed area 17 and located at the bottom 102 of the body 10.

A ratchet wheel 20 is rotatably received in the through hole 11 and includes a ratchet portion 21 defined in the outer periphery thereof. A connection portion 22 is formed to the ratchet wheel 20, wherein the connection portion 22 is a polygonal hole in this embodiment. A first pivotal portion 23 and a second pivotal portion 25 are respectively formed on two ends of the ratchet wheel 20. The first pivotal portion 23 has a top groove 24, and the second pivotal portion 25 has a bottom groove 26. The second pivotal portion 25 is pivotably engaged with the through hole 11 and the bottom recessed area 17.

A pawl 30 is movably received in the recess 12 and has a toothed face 31 defined in the front side thereof, and the toothed face 31 is engaged with the ratchet portion 21 of the ratchet wheel 20. The pawl 30 has a positioning portion 32 defined in the first end thereof, and the positioning portion 32 faces the entrance 141. The pawl 30 has a contact end 33 defined the second end thereof, and the contact end 33 contacts the inner periphery of the recess 12. A second angle is defined between the contact end 33 and the rear side of the pawl 30 that faces the inner end of the first recess 12. The second angle is matched with the first angle 121.

A resilient member 40 is received in the recess 12 and biased between the inner end of the receiving slot 14 and the positioning portion 32 to engage the toothed face 31 of the pawl 30 with the ratchet portion 21 of the ratchet wheel 20.

A top ring 50 is received in the top recessed area 15 and contacts the first shoulder 16 and the top of the protrusion 13. The top ring 50 has an inner periphery 51 thereof mounted to the first pivotal portion 23. The top ring 50 further includes a first lid 52 extending therefrom, so that the top ring 50 is shaped to cover the recess 12 at the top 101 of the body 10, the pawl 30 and the resilient member 40. The outside of the first lid 52 matched with the inner periphery of the first recess 122.

A top clip 60 is engaged with the top recessed area 15 and the top groove 24, and contacts the top ring 50 to restrict the ring 50 from separating from the ratchet wheel 20.

A bottom ring 70 is engaged with the bottom recessed area 17 and contacts the second shoulder 18. The bottom ring 70 having a second inner periphery 71 which is pivotably connected to the second pivotal portion 25. The bottom ring 70 has a second lid 72 extending from the outer periphery thereof so as to clover the recess 12 at the bottom 102 of the body 10, the pawl 30 and the resilient member 40. The outside of the second lid 72 is matched with the inner periphery of the second recess 123.

A bottom clip 80 is engaged with the bottom groove 26 and contacts the second shoulder 18, and the bottom clip 80 presses the bottom ring 70. The ratchet wheel 20 is restricted by the top ring 50, the top clip 60, the bottom ring 70 and the bottom clip 80 so as to be pivotably received in the through hole 11.

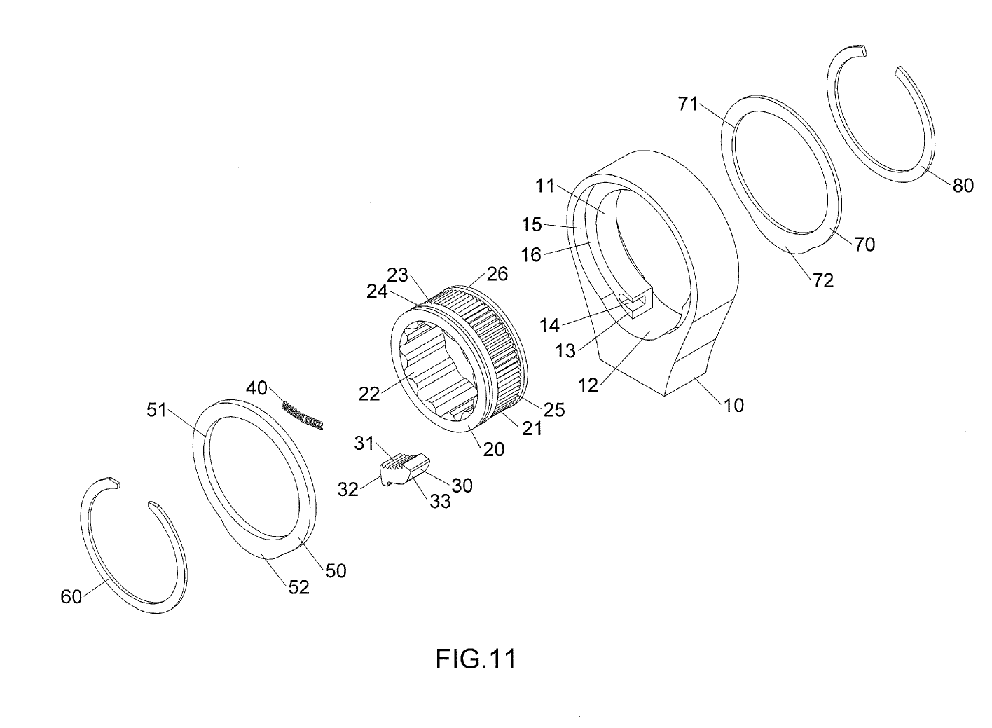

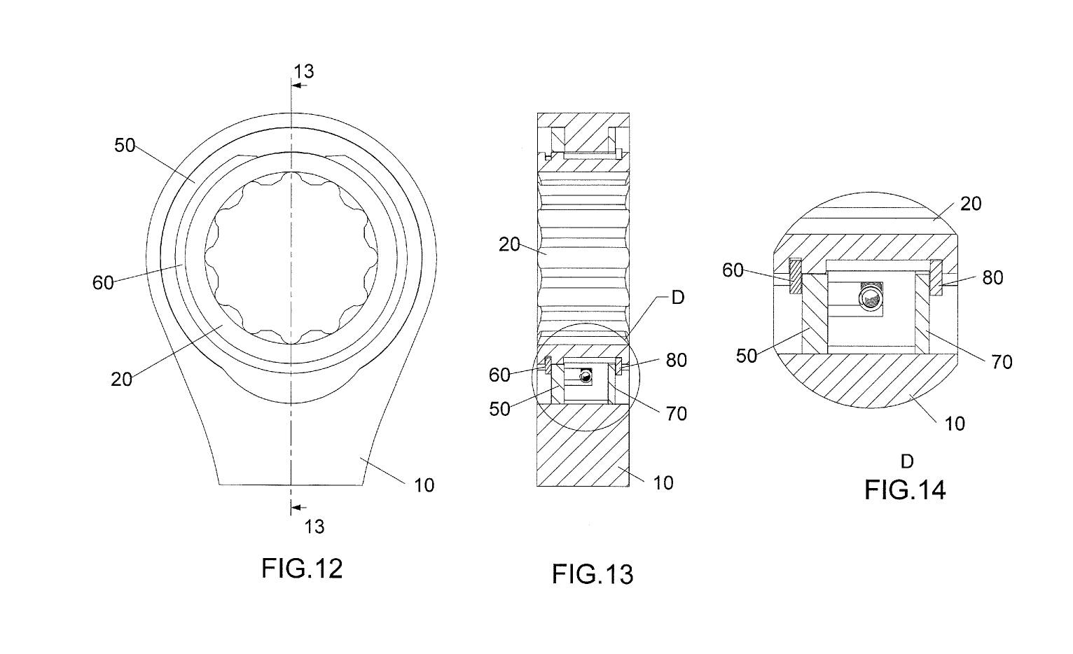

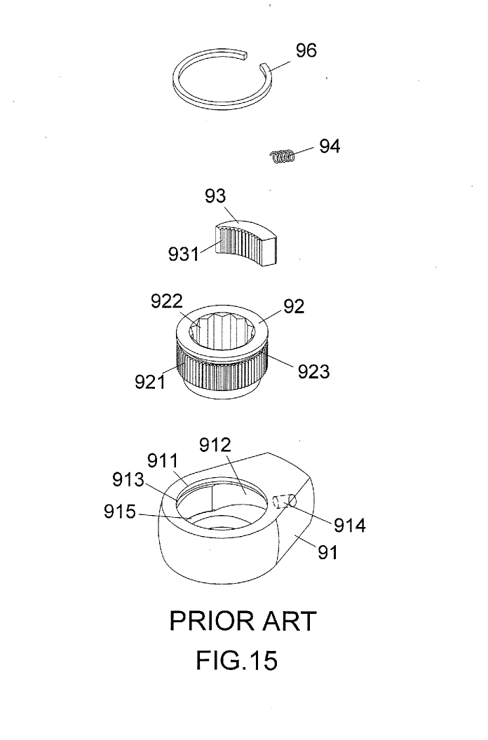

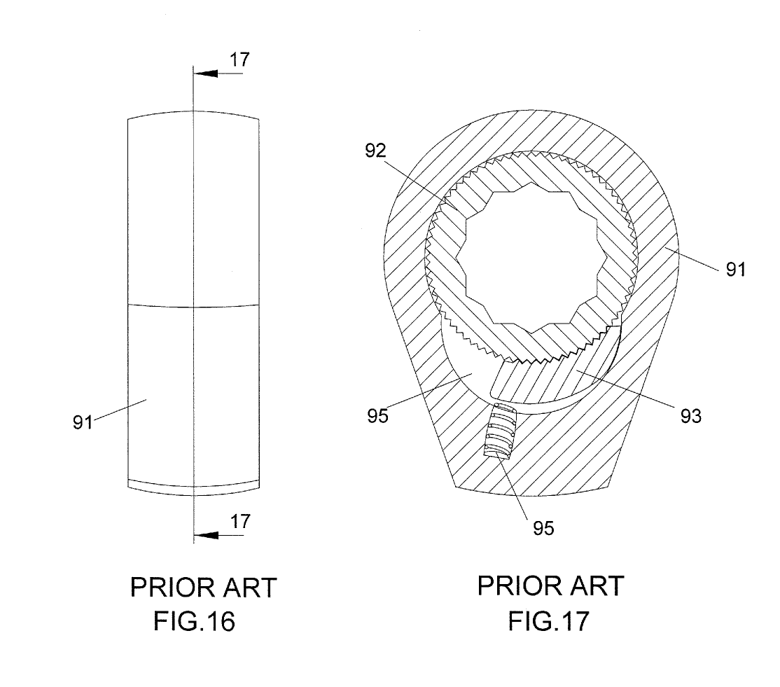

As shown in FIGS. 11 to 14, the second embodiment is disclosed, wherein the recess 12 does not have the first and second recesses 122, 123 as shown in FIG. 1. The first and second pivotal portions 23, 25 have the same diameter which is larger than or equal to the diameter of the ratchet portion 21. The first lid 52 of the first ring 50 and the second lid 72 of the bottom ring 70 are matched with the inner periphery of the recess 12.

The connection portion 22 of this embodiment is a rectangular protrusion.

The advantages of the present invention are that the through hole 11 and the recess 12 open to the top 101 and the bottom 102 of the body 10. The receiving slot 14 and the top recessed area 15 open to the top of the body 10, and the bottom recessed area 17 opens to the bottom 102 of the body 10, so that they are easily manufactured.

The through hole 11 is defined through the body 10 so that the feeding of the tool making the through hole 11 does not need to be carefully controlled.

The through hole 11, the recess 12 and the receiving slot 14 are able to be made by the same one drilling tool without worry of accumulation of tolerance.

The through hole 11, the recess 12 and the receiving slot 14 are opened to the top of the body 10, so that they can be done by one time of punching after being forged.

The body 10 can be manufactured by either drilling or punching, the options are plenty.

The receiving slot 14 needs not to be made by any extra process so as to save manufacturing cost.

As shown in FIG. 1, the ratchet wheel 20 is positioned in the through hole 11 by the top ring 50, the bottom ring 70, the top and bottom clips 60, 80, so that the ratchet wheel 20 is easily removed from the body 10.

The first pivotal portion 23 and the second pivotal portion 25 are respectively connected to the inner periphery of the top ring 50 and the through hole 11 so that the ratchet wheel 20 is stably installed.

When removing either one of the top clip 60 or the bottom clip 80, the ratchet wheel 20 is conveniently removed from the through hole 11 to replace parts in the body 10.

While we have shown and described the embodiment in accordance with the present invention, it should be clear to those skilled in the art that further embodiments may be made without departing from the scope of the present invention.

What is claimed is:

1. A ratchet wrench comprising:
a body (10) having a through hole (11) defined through a top (101) and a bottom (102) thereof, the through hole (11) having a recess (12) defined in an inner periphery thereof, a center of the recess (12) located in the through hole (11), the recess (12) being opened through the top (101) and the bottom (102) of the body (10), a protrusion (13) extending from one end of the recess (12) and having a receiving slot (14) which includes an opening (140) and an entrance (141), the opening (140) being opened through the top (101) of the body (10), the entrance (141) of the receiving slot (14) communicating with and facing an interior of the recess (12), a top recessed area (15) defined in the top (101) of the body (10) and sharing a common axis with the through hole (11), a first shoulder (16) formed between the top recessed area (15) and the through hole (11), the first shoulder (16) being in flush with a top of the protrusion (13), a bottom recessed area (17) defined in the bottom (102) of the body (10) and sharing the common axis with the through hole (11);
a ratchet wheel (20) rotatably received in the through hole (11) and having a ratchet portion (21) defined in an outer periphery thereof, a connection portion (22) formed to the ratchet wheel (20), a first pivotal portion (23) and a second pivotal portion (25) respectively formed on two ends of the ratchet wheel (20), the first pivotal portion (23) having a top groove (24), the second pivotal portion (25) having a bottom groove (26), the second pivotal portion (25) pivotably engaged with the through hole (11) and the bottom recessed area (17);
a pawl (30) movably received in the recess (12) and having a toothed face (31) defined in a front side thereof, the toothed face (31) engaged with the ratchet portion (21) of the ratchet wheel (20), the pawl (30) having a positioning portion (32) defined in a first end thereof, the positioning portion (32) facing the entrance (141), the pawl (30) having a contact end (33) defined in a second end thereof, the contact end (33) contacting the inner periphery of the recess (12);
a resilient member (40) received in the recess (12) and biased between an inner end of the receiving slot (14) and the positioning portion (32) to engage the toothed face (31) of the pawl (30) with the ratchet portion (21) of the ratchet wheel (20);
a top ring (50) received in the top recessed area (15) and contacting the first shoulder (16) and the top of the protrusion (13), the top ring (50) having an inner periphery (51) thereof mounted to the first pivotal portion (23), the top ring (50) being shaped to cover the resilient member (40), the top ring (50) having a first lid (52) extending from an outer periphery thereof and the first lid (52) covering the recess (12) at the top (101) of the body (10);
a top clip (60) engaged with the top groove (24) and contacting the ring (50) to restrict the ring (50) from separating from the ratchet wheel (20);
a bottom ring (70) engaged with the bottom recessed area (17) and contacting the second shoulder (18), the bottom ring (70) having a second inner periphery (71) which is pivotably connected to the second pivotal portion (25), the bottom ring (70) having a second lid (72) extending from an outer periphery so as to clover the recess (12) at the bottom (102) of the body (10), and
a bottom clip (80) engaged with the bottom groove (26) and contacting the second shoulder (18), the ratchet wheel (20) being restricted by the top ring (50), the top clip (60), the bottom ring (70) and the bottom clip (80) so as to be pivotably received in the through hole (11).

2. The ratchet wrench as claimed in claim 1, wherein a first angle (121) is defined between the inner end of the recess (12) and the inner periphery of the recess (12), the first angle (121) is between 90 to 120 degrees, a second angle is defined between the contact end (33) and a rear side of the pawl (30) that faces the inner end of the recess (12), the second angle is matched with the first angle (121).

3. The ratchet wrench as claimed in claim 1, wherein a first angle (121) is between 90 to 120 degrees.

4. The ratchet wrench as claimed in claim 1, wherein an inner diameter of the bottom recessed area (17) is the same as an inner diameter of the top recessed area (15), the top and the bottom recessed areas (15, 17) are located symmetrically to the through hole (11).

5. The ratchet wrench as claimed in claim 1, wherein the connection portion (22) is a polygonal hole or a rectangular protrusion.

6. The ratchet wrench as claimed in claim 1, wherein a diameter of the first pivotal portion (23) is smaller than a diameter of the ratchet portion (21).

7. The ratchet wrench as claimed in claim 1, wherein a diameter of the second pivotal portion (25) is smaller than a diameter of the ratchet portion (21).

8. The ratchet wrench as claimed in claim 1, wherein an inner diameter of the first pivotal portion (23) is the same as an inner diameter of the second pivotal portion (25), the first and second pivotal portions (23, 25) are located symmetrically to the ratchet portion (21).

9. The ratchet wrench as claimed in claim 1, wherein the positioning portion (32) is a circular slot or a cylindrical rod.

10. The ratchet wrench as claimed in claim 1, wherein the top clip (60) is a resilient C-clip.

11. The ratchet wrench as claimed in claim 1, wherein the top recessed area (15) intersects the recess (12) at the top (101) of the body (10).

12. The ratchet wrench as claimed in claim 1, wherein the bottom recessed area (17) intersects the recess (12) at the bottom (102) of the body (10).

13. The ratchet wrench as claimed in claim 1, wherein a first recess (122) is defined in an inner periphery of the top recessed area (15) and located at the top (101) of the body (10), an outside of the first lid (52) of the top ring (50) is matched with an inner periphery of the first recess (122).

14. The ratchet wrench as claimed in claim 1, wherein a second recess (123) is defined in an inner periphery of the bottom recessed area (17) and located at the bottom (102) of the body (10), an outside of the second lid (72) of the bottom ring (70) is matched with an inner periphery of the second recess (123).
